(19) United States
(12) Patent Application Publication
(10) Pub. No.: US 2007/0187435 A1
(43) Pub. Date: Aug. 16, 2007

(54) Concurrent use water cooler

(76) Inventor: Krista Gould Quirk, Philadelphia, PA (US)

Correspondence Address: Michael G. Crilly, Esquire, 104 South York Road, Hatboro, PA, 19040, US

(21) Appl. No.: 11/706,736

(22) Filed: Feb. 15, 2007

Related U.S. Application Data
(60) Provisional application No. 60/773,900, filed on Feb. 16, 2006.

(51) Int. Cl. B67D 5/06; B67D 3/00

(52) U.S. Cl. 222/481; 222/185.1

(57) ABSTRACT

A concurrent use water cooler capable of simultaneously dispensing a single fluid to two or more users is presented. The invention includes a container having a single reservoir therein, a lid contacting and removable from the container, at least two spigots disposed about and attached to the container, a vent hole, and a plug to close the vent hole. Spigots communicate with the single reservoir and enable the gravity-fed dispensing of a single fluid. At least one spigot has a threaded spout allowing attachment of a fluid supply line. The threaded spigot is biased to resist the static pressure associated with fluid within the supply line so as to remain closed unless actuated by the user. An optional stand contacts and supports the water cooler. One or more cup dispensers may be attached to the container or stand. The present invention has immediate applicability to sports teams, military units, construction crews, and the like, where two or more persons consume a potable liquid.

### CROSS REFERENCE TO RELATED APPLICATIONS

This application is based upon and claims priority under 35 U.S.C. §119(e) from U.S. Provisional Application No. 60/773,900 filed Feb. 16, 2006, entitled Concurrent Use Water Cooler, the contents of which are hereby incorporated in its entirety by reference thereto.

### FEDERALLY SPONSORED RESEARCH OR DEVELOPMENT

None.

### BACKGROUND OF INVENTION

1. Field of the Invention

The present invention generally relates to a fluid container and dispenser. Specifically, the invention is a water cooler having two or more spigots disposed about a single reservoir so as to enable the concurrent dispensing of a single fluid to multiple users while avoiding the formation of a vacuum. At least one spigot is a manually-controllable, bi-directional valve allowing discharge of water from the reservoir and refill of the same.

2. Description of the Related Art

A variety of water coolers are provided in the related arts. Several examples are discussed below to clarify the related arts and distinguish each from the present invention.

Reinmuth, U.S. Pat. No. 6,230,513, describes a semi-portable, thermally insulated water cooler which is supplied by a municipal water source via a feeder hose. The water cooler includes an ice filled container having a spiraled water conduit which is connected to the municipal water source at one end and a plurality of flexible dispensing hoses at the other end. Fluid is dispensed to the users under pressure. A bypass valve may be attached at the input end of the water cooler to divert and vent stagnant water within the hose before entering the water cooler. Otherwise, the bypass valve allows water to freely flow into the coil within the water cooler. The bypass valve does not allow water to be drained from the water cooler.

Brent, U.S. Pat. No. 6,783,034, describes a liquid carrier article having a drain spigot and a dispensing spigot communicating with two physically separate cavities within a single apparatus. The drain spigot is provided at the bottom of the carrier allowing for the release of water from melted ice and liquid spillage from the interior cavity of the carrier. The dispensing spigot is provided at the top of the carrier and is connected to a container within the carrier which holds a potable liquid under pressure. Ice or briquettes are provided within the interior cavity of the carrier and contact the exterior of the container so as to cool or heat the pressurized fluid. Melted ice and internal spillage are physically separated from the pressurized fluid within the container.

Fellows, U.S. Pat. No. 128,956, describes a water and liquor cooler with a plurality of spigots, a plurality of bottles, and a partitioned space having an upper cavity and a lower cavity. A single spigot communicates with each bottle to dispense the fluid therein. Large spigots are provided to dispense fluid from both upper and lower cavities disposed about the partition. Both large and small spigots are opened and closed by a small wrench or a key-wrench so as to prevent use by unauthorized parties. As such, Fellows prevents the simultaneous opening and closing of two or more spigots. Furthermore, no vent means is provided within the structure to avoid the formation of a vacuum caused by fluid flow from two or more spigots. A vacuum would impede fluid flow from the cooler when two or more spigots are open.

Loew, U.S. Pat. No. 5,890,629, and Brunner et al., U.S. Pat. No. 912,281, describe apparatuses for dispensing beverages having a plurality of spigots and like number of beverage containers. Each spigot communicates with a single container to dispense the fluid therein.

Guay et al., U.S. Pat. No. 5,121,612, describes a water separator for separating cooled and uncooled water in a refrigerated bottled drinking water cooler well. A first spigot communicates with and dispenses water from a reservoir of uncooled water. A second spigot communicates with and dispenses water from a reservoir of cooled water. While the reservoir of cooled water is fed by the reservoir of uncooled water, there is no remixing of the fluid after separation into the two reservoirs and prior to dispensing via the separate spigots.

Yanes, U.S. Pat. No. 4,491,244, describes a portable, coolable beverage dispenser having a drain valve and spigot disposed at the lower end of the invention. The drain valve communicates with a chamber within the dispenser allowing the removal of water which accumulates from the melting of ice therein. The spigot is attached to a reservoir within the dispenser which communicates with a pliable, fluid-filled vessel providing a container within the dispenser. Ice and melted ice within the chamber are physically separated from fluid within the reservoir and vessel.

As is readily apparent from the discussions above, the related arts describe the application of spigots to dispense an equal number of physically separated fluids residing within an equal number of separate reservoirs. The related arts also describe the application of spigots to dispense fluid from partitioned cavities. The related arts do not describe a water cooler having two or more spigots about a single reservoir for the simultaneous gravity-fed dispensing of a single fluid to at least two users while avoiding the formation of a vacuum which would impede the dispensing function of the water cooler. Furthermore, the related arts do not provide a manually operable bi-directional, refill mechanism within one of the spigots which would otherwise dispense fluid from the water cooler.

Therefore, what is required is a low-cost and mechanically simple water cooler having a single reservoir with two or more spigots capable of dispensing a gravity-fed, single temperature fluid to two or more users while avoiding the formation of a vacuum and allowing the manually controllable refill of the reservoir.

### SUMMARY OF INVENTION

An object of the present invention is to provide a low-cost and mechanically simple water cooler having a single reservoir with two or more spigots capable of dispensing a gravity-fed, single temperature fluid to two or more users while avoiding the formation of a vacuum and allowing the manually controllable refill of the reservoir.

The concurrent use water cooler includes a container having a single reservoir therein, a lid contacting and removable from the container, and at least two spigots disposed about and attached to the container. Spigots communicate with the single reservoir and enable the gravity-fed dispensing of a single, uniform temperature fluid. At least one spigot is bi-directional and includes a threaded spout for the attachment of a fluid supply line so as to allow a user to refill the reservoir as conditions and usage require. The lid includes a vent hole and plug to prevent the formation of a vacuum when multiple spigots are simultaneously engaged to dispense fluid from the reservoir.

In yet other embodiments, the water cooler might include two or more cup dispensers disposed about and attached to the container adjacent to the spigots.

In still other embodiments, the water cooler might include a stand contacting and supporting the water cooler so as to allow simultaneous access to and use of all spigots.

The described invention provides advantages over the related arts. The present invention is mechanically simple and portable. The present invention facilitates the simultaneous dispensing of a single fluid for consumption by two or more persons in a time expedient fashion.

### BRIEF DESCRIPTION OF DRAWINGS

FIG. 1 is a perspective view of the present invention with partial section view showing a plurality of spigots disposed along and about the wall of the water cooler.

FIG. 2 is a partial section view of the water cooler showing a single reservoir communicating with a plurality of spigots.

FIG. 3 is a partial section view showing attachment of an exemplary spigot through the wall of the water cooler.

FIG. 4 is a partial section view showing attachment of a supply/drainage line to a spigot with threaded spout.

FIG. 5 is partial section view of the lid showing a removable plug employed to avoid formation of a vacuum during use of the water cooler.

FIG. 6 is a perspective view of the present invention supported by an exemplary stand each with several optional cup dispensers.

### REFERENCE NUMERALS

1 Water cooler
2a–2f Spigot
3a–3c Recess
4 Wall
5 Lid
6 Reservoir
7 Gasket
8 Ring
9 Nut
10 Spout
11 Male coupler
12 Female coupler
13 Fluid supply line
14 Pressurized fluid
15 Spigot
16 Stand
17a–17d Cup dispenser
18a–18c Extensible leg
19a–19c Hinge
20 Brace
21 Plug
22 Container
23 Vent hole
24 Tube
25 Exterior surface
26 Interior surface
27 Flange
28 Button
29 Support plate
30 Ground
31 Threads

### DETAILED DESCRIPTION OF INVENTION

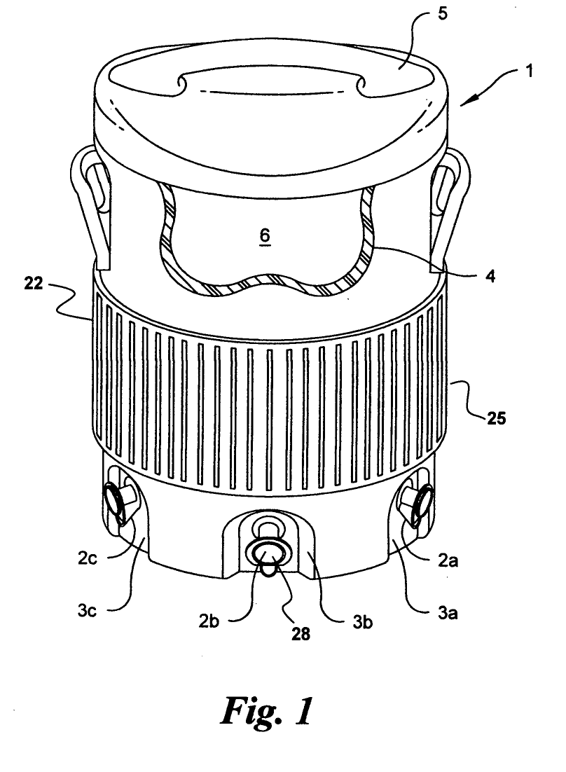

Referring now to FIG. 1, the present invention, generally referred to as a water cooler 1, includes a container 22 having a generally cup-shaped construction with a removable lid 5 at one end and two or more spigots 2a-2c adjacent to the opposite end.

The container 22 may be any commercially available water cooler 1 having a single reservoir 6 therein which is sufficiently voluminous so as to store a potable fluid for consumption by two or more persons. One exemplary container 22 is a heavy-duty, ten gallon water cooler sold by the IGLOO Products Corp. of Shelton, Conn.

The lid 5 is generally shaped so as to completely cover and close the open end of the container 22. The lid 5 may be plug-shaped and conform to the wall 4 at the open end of the container 22, as shown in FIG. 1, or threaded to match complimentary threads along the wall 4 for a mechanical lock. The wall 4 of the container 22 may be a single member composed of a metal or a polymer material or of two or more layers of metals and polymers, including at least one insulating composition.

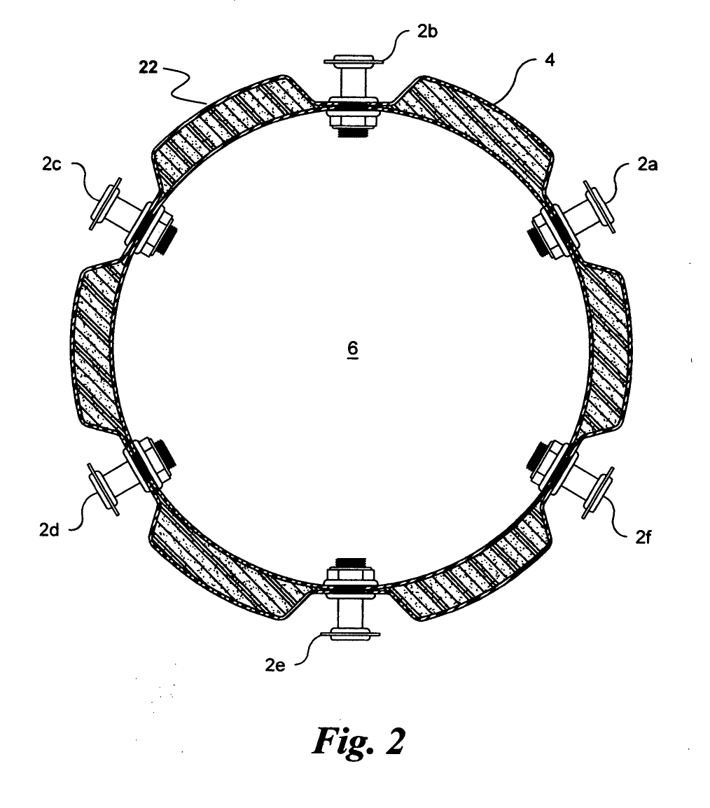

The spigots 2a-2c are manually activated valves capable of dispensing a fluid in a controlled fashion. Spigots 2a-2c may include push button devices or the like. One exemplary spigot 2a-2c is a push-button device, part number 9590, sold by the IGLOO Products Corp. of Shelton, Conn., as represented in FIGS. 1-4. Spigots 2a-2c may be located within recesses 3a-3c so as to minimize their projection beyond the exterior surface 25 of the wall 4, as shown in FIGS. 1-2, or flush mounted to the wall 4 so as to project there from.

Referring now to FIG. 2, the reservoir 6 is shown in a sectional view with six spigots 2a-2f attached to the wall 4 of the container 22. Each spigot 2a-2f allows a single fluid residing within the reservoir 6 and having a single uniform temperature to be dispensed in a controlled fashion by an equal number of users. The number of spigots 2a-2f possible with the present invention is at least two.

The maximum number of spigots 2a-2f is generally related to the circumference of the container 22. Spacing between spigots 2a-2f should be sufficient so as to allow a user to manually operate a spigot 2a-2f and dispense fluid into a cup or the like without interfering with the use of adjacent spigots 2a-2f.

Spigots 2a-2f may be positioned about the circumference of the container 22 so as to be disposed along a single elevation, preferably near or at the bottom of the container 22 so as to maximize the gravity-fed flow of fluid there from, or two or more elevations relative to the bottom of the container 22. While an infinite variety of designs are possible, it is preferred to have at least five spigots 2a-2f disposed about the lower portion of the container 22 with at least 4-inches between spigots 2a-2f.

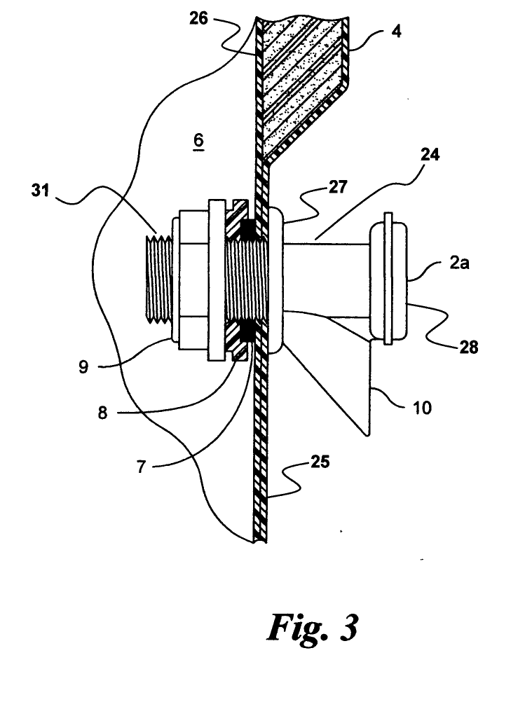

Referring now to FIG. 3, an exemplary attachment scheme is shown for a push-button type spigot 2a to the wall 4. A hole is either mechanically drilled through or molded into the wall 4 from the exterior surface 25 to the interior surface 26 so as to provide an opening at least as large as the tube 24 portion of the spigot 2a. The tube 24 should be sufficiently long so as to completely transverse the thickness of the wall 4 with a portion extending into the reservoir 6 and having threads 31 thereon.

The spigot 2a is mechanically fastened to the wall 4 to form a watertight seal. A gasket 7 composed of deformable or compressible material, one example being rubber, is placed over the tube 24 so as to contact the interior surface 26. A ring 8 composed of a generally rigid and non-compressible material, one example being polypropylene, is placed over the tube 24 so as to contact the gasket 7. A nut 9 composed of a generally rigid and non-compressible material, one example being polypropylene, is threaded onto complimentary threads 31 along the tube 24 and tightened to compress the gasket 7 between ring 8 and wall 4.

The spigot 2a portion extending beyond the exterior surface 25 includes a finger actuated button 28 or the like, also shown in FIG. 1, attached thereafter to a valve assembly within the tube 24 and a spout 10 disposed at an angle with respect to the tube 24. A flange 27 may be disposed about the tube 24 so as to contact the exterior surface 25 and provide a second watertight seal.

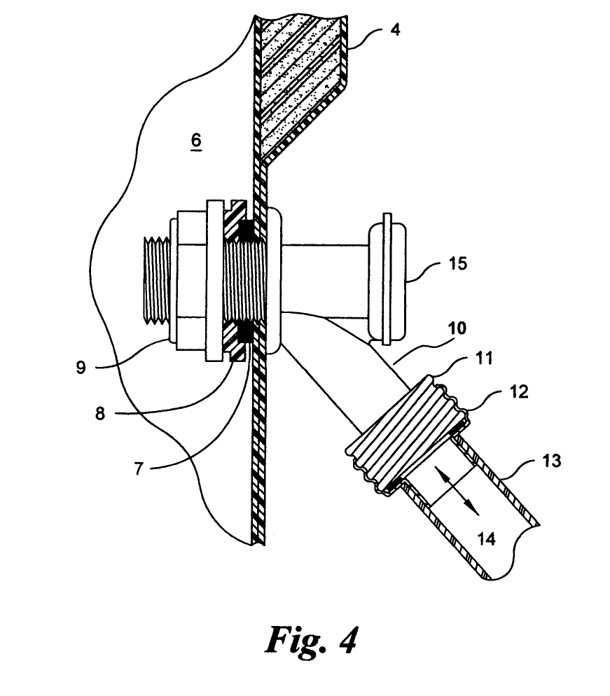

Use of the present invention by two or more persons quickly drains fluid from the reservoir 6. Thus, it is advantageous to include a means to refill the present invention without either removing the lid 5 or moving the water cooler 1 to a water supply. Referring now to FIG. 4, a threaded male coupler 11 is shown at the end of and disposed about the spout 10. In this embodiment, the male coupler 11 facilitates connection to a female coupler 12 at one end of a fluid supply line 13, one example being a garden hose. The male coupler 11 may be molded, machined, or mechanically fastened to the spout 10.

The dispensing functionality of the spigot 15 enables refill of the reservoir 6 by allowing pressurized fluid 14 within the fluid supply line 13, and originating from a municipal water supply or the like, to enter the reservoir 6 whenever the button or lever is manually engaged so as to open the valve mechanism within the spigot 15. As such, the valve should resist the static pressure of the fluid within the fluid supply line 13 so as to prevent the mechanism from opening unless manually engaged by a user. The described use of the spigot 15 in a bi-directional fashion simplifies the mechanical complexity of refill by providing a user activated and controlled mechanism that is normally closed.

Commercially available button-type spigots 2a-2f include a plunger-type element which is engaged in the closed position by a spring when not actuated by a finger. As such, commercial spigots used with water coolers are designed to allow fluid flow in one direction only.

In the present invention, the spring must be sufficiently stiff so as to resist the fluid pressure within a municipal water system, thus biasing the spigot function so as to remain closed. However, the same spring must be sufficiently compressible to allow the valve to open when a force is applied onto the finger actuated button 28. While spring stiffness is design and application dependent, stiffness is increased by application of a thicker or heavier spring or by use of a stronger spring material.

Use of the present invention by two or more persons will cause a vacuum or negative pressure to form within the reservoir 6 when fluid is quickly removed from the container 22 with watertight lid 5. Fluid flow from the spigots 2a-2f is either partially or completely impeded depending on the magnitude of the vacuum.

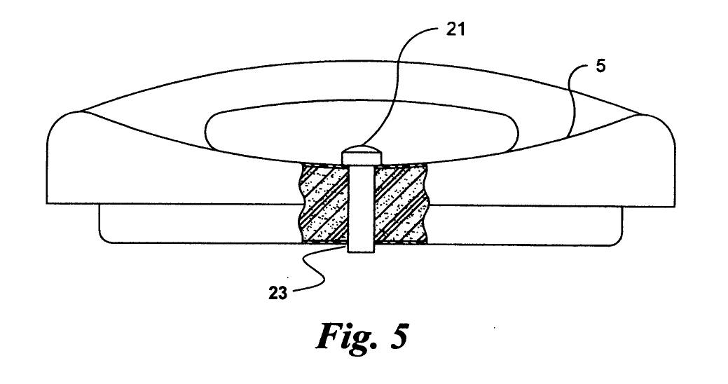

Referring now to FIG. 5, the lid 5 from FIG. 1 is shown having a vent hole 23 which completely traverses the thickness of the lid 5 with a plug 21 therein. The vent hole 23 may be mechanically drilled or molded into the lid 5. The vent hole 23 provides an opening which allows air to enter the reservoir 6 as fluid exits the spigots 2a-2f, thereby avoiding the formation a negative pressure or vacuum within reservoir 6.

The plug 21 is generally a t-shaped element composed of a polymer material and dimensioned so as to be mechanically coupled to the vent hole 23 in a removable fashion. It is likewise desired for the plug 21 to form a watertight seal with the lid 5 when seated within the vent hole 23. The plug 21 may be knurled or otherwise shaped so as allow the user to grasp and pull the plug 21 for its removal.

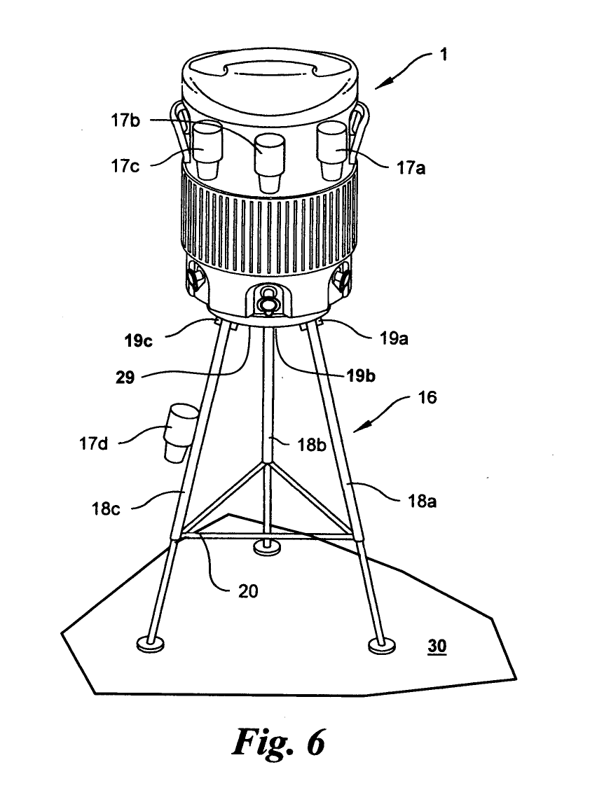

As is apparent from the description above, the concurrent use of two or more spigots 2a-2f about the present invention requires simultaneous access to all spigots 2a-2f. Referring now to FIG. 6, the water cooler 1 described above is shown contacting and supported by a stand 16. It is preferred that the stand 16 support the container 22 at a height which allows convenient and unobstructed access to all spigots 2a-2f, although other heights are possible.

While a variety of expandable and collapsible designs are possible, it is preferred for the stand 16 to include three extensible legs 18a-18c arranged in a tripod-type fashion, examples including devices described by Neuwirth in U.S. Pat. No. 2,490,369 and Hutton in U.S. Pat. No. 6,179,266. However, four or more legs may be advantageous in some applications. Each extensible leg 18a-18c is attached to a single support plate 29 via a hinge 19a-19c, respectively. Hinges 19a-19c and extensible legs 18a-18c allow the stand 16 to be collapsed for storage and adjusted during use to level the water cooler 1. When extended and deployed, the extensible legs 18a- 18c are mechanically locked and fixed via a brace 20, as shown in FIG. 6.

The support plate 29 is a planar element having the general shape of the bottom of the container 22. When properly deployed, the support plate 29 should be horizontally disposed relative to the ground 30 so as to support the water cooler 1 in a vertically upright position. It is likewise possible for the support plate 29 to be rotatable with respective to the stand 16 about a vertical axis relative to the stand 16. Two or more commercially available cup dispensers 17a-17d may be mechanically fastened to the container 22 or to the extensible legs 18a- 18c.

The description above indicates that a great degree of flexibility is offered in terms of the present invention. Although the present invention has been described in considerable detail with reference to certain preferred versions thereof, other versions are possible. Therefore, the spirit and scope of the appended claims should not be limited to the description of the preferred versions contained herein.

What is claimed is:

1. A concurrent use water cooler comprising:
(a) a container having a single reservoir therein;
(b) a lid contacting and closing said container in a removable fashion;
(c) at least two spigots disposed about and attached to said container, each said spigot communicating with said single reservoir and enabling the gravity-fed dispensing of a single uniform temperature fluid from said single reservoir, at least one said spigot having a threaded spout and biased so as to remain closed when connected to a fluid supply line, said spigot allowing bidirectional flow of said fluid into and out of said reservoir;
(d) a vent hole through said lid to prevent formation of a vacuum when two or more said spigots are open and dispensing said fluid; and
(e) a plug removably attached within said vent hole.

2. The concurrent use water cooler of claim 1, further comprising:
(f) at least two cup dispensers disposed about and attached to said container adjacent to said spigots.

3. The concurrent use water cooler of claim 1, further comprising:
(f) a stand contacting and supporting said water cooler so as to allow access to all said spigots.

4. The concurrent use water cooler of claim 3, further comprising:
(g) at least one cup dispenser attached to said stand.
